(19) United States
(12) Patent Application Publication
(10) Pub. No.: US 2025/0029137 A1
(43) Pub. Date: Jan. 23, 2025

(54) INDIVIDUALIZED COUPON OFFERS BASED ON CONSUMER NFT BEHAVIOR

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,073

(22) Filed: May 20, 2024

Related U.S. Application Data
(60) Provisional application No. 63/467,703, filed on May 19, 2023.

(51) Int. Cl. G06Q 30/0207; G06Q 20/36; G06Q 20/38

(52) U.S. Cl. CPC G06Q 30/0224; G06Q 20/367; G06Q 20/3829

(57) ABSTRACT

Individual consumer NFT behavior is collected and analyzed. Various offers from retailers are targeted to certain consumer NFT behavior along with other characteristics, such as demographics, location, time, and the like. Once a match is identified, an individualized coupon offer is made to the consumer. By offering relevant and personalized promotions, businesses can increase customer loyalty, engagement, enhance user experience and potentially increase sales.

### CROSS-REFERENCE TO RELATED APPLICATIONS

The invention claims priority under 35 USC 119 (e) to 63/467,703, entitled INDIVIDUALIZED COUPON OFFERS BASED ON CONSUMER NFT BEHAVIOR, and filed May 19, 2023, by Ramde et al., the contents of which are hereby incorporated in its entirety.

### FIELD OF THE INVENTION

The invention relates generally to computer networks, and more specifically, to generate promotions and coupon offers to consumers based on NFT behavior.

### BACKGROUND

Individualized coupons based on behavior patterns can provide several benefits for businesses. By offering relevant and personalized promotions, businesses can increase customer engagement and loyalty, enhance their experience and potentially increase sales. Additionally, by targeting customers with promotions more effectively, businesses can reduce the cost and effort associated with offering coupons and discounts, and increase the likelihood of a successful promotion and sale.

As retailers seek more engagement and create novel experiences for their users, personalized coupons may serve as a medium for them to directly engage with the users one on one, and customize their experiences. As such adding transactional capabilities is desirable, specifically as it relates to transacting in digital assets or NFTs. These digital assets can represent a variety of experiences from coupon codes, to loyalty rewards, to gift vouchers, a digital avatar, or a set of stickers, a survey, or simply a recognition of a transaction itself.

As mobile commerce gains more popularity, specially amongst new generations of users, shopping will be increasingly intertwined with customer experience. Not having transactional capabilities as part of the customer experience will be detrimental for businesses. Today, most coupons are sent via emails, or standard mail and are hard to access at the Point of Sale terminal as users rarely remember to bookmark them. As a result, users are unhappy with the experience and feel like they overpaid for the merchandise, despite being a loyal shopper at the store. Some applications redirect users to a mobile application or a web application to complete the transactions by providing them with a URL link. This is inefficient as the business hands over a customer to another application and the customer may simply drop off and never complete the transaction. For example, today it is impossible for a shopper to bookmark all of their personalized coupon codes or incentives for various businesses they interact with in a central common place. The reason is that all of these businesses are built on siloed datasets of customer information and there is no reason to make their data set and information interoperable with that of another business or retailer. It is also cumbersome for a shopper to buy a digital product and have its physical counterpart shipped to a physical home or office address by virtue of the same transaction.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated. For example, once minted, an NFT is typically offered for sale or acquisition via an NFT marketplace or other token sale platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, closed to external sources. This can be problematic when external data is needed to satisfy conditions of the smart contract.

By using a blockchain-based system and specifically NFTs for personalized coupons based on consumer behavior, the customer experience could be significantly enhanced. Businesses and brands of all sizes can easily engage with their users via NFTs that can represent giveaways, loyalty rewards, gifts, coupons, vouchers, etc. as needed. The decentralized nature of blockchain could also make it more difficult for unauthorized individuals to access or tamper with such NFT based utilities. Moreover, blockchain-based resource and communication tools could facilitate data sharing between various departments of the business, such as customer service, marketing, and operations. It can also facilitate data sharing between a business and its partners for example, between Walmart and its suppliers. Additionally, the use of smart contracts on a blockchain could potentially automate various aspects of the customer experience and customer success programs deployed widely in organizations. Finally, the use of NFTs incentivizes the holders of the NFTs with recognition and rewards while reinforcing positive behaviors, skills or outcomes for natural communities of said businesses, organizations, suppliers, users, and other ecosystem participants, who could all benefit from sharing data in a unique manner.

Therefore, what is needed is a robust technique for generating coupon offers to consumers based on their NFT behavior and interaction with NFTs.

### SUMMARY

To meet the above-described needs, methods, computer program products, and systems for generating coupon offers to consumers based on their NFT behavior, collection of NFTs (or their characteristics and actual or implied use) and interaction with NFTs.

In one embodiment, a retailer initiates a transaction by sending an offer to a consumer. The consumer completes the transaction by accepting or activating the offer in actuating a digital button or otherwise. A digital wallet is generated for the user if one is not otherwise specified. The transaction and the personalized coupon associated with it is recorded as an NFT.

In one embodiment, an individual consumer NFT behavior is collected and analyzed. Various offers from retailers are targeted to holder(s) of certain NFTs based on behaviors or characteristics related to their NFTs associated with certain characteristics, such as demographics, location, time, other NFT collections or previous interactions with other NFTs and the like. Once a match is identified, an individualized coupon offer is made to the consumer.

In one embodiment, consumer data may include name, affiliation, business interests, retailer specific information, or any other information related to their employment etc. In addition to a user wallet, the system may also create a decentralized identity for the users. This decentralized identity can further be associated with the user's external accounts such as a third party loyalty rewards program, or a social network etc.

In one embodiment, the system is governed by configurable smart contracts. It is envisioned that the retail ecosystem comprising brands, sponsors, venues, malls, commercial real estate owners, are all incentivized to transact within a customized network. It may be desirable from a business and convenience perspective that the digital assets or coupons may only be traded or governed by the rules in the smart contract(s). In one embodiment, the digital assets or coupons may be blocked or restricted from trading on one or more third party systems, exchanges, protocols etc., thereby making it a singular or strategic registry of retail specific or focused coupons or digital assets.

Advantageously, users automatically receive coupons related to NFT interactions or behaviors associated or deduced from one or more NFTs or interactions. Using NFTs for promotions or coupons has a number of potential benefits. First, it could help to reduce fraud and counterfeiting, as each NFT coupon would be unique and tied to a specific individual or account. Additionally, it could provide a new way for businesses to incentivize or tailor customer loyalty and reward their most dedicated customers. Finally, because each NFT coupon is tied to a specific individual or account, it can be easily tracked and monitored. This can help businesses to better understand their customers' buying habits and preferences, surface actionable information and to create more effective marketing campaigns.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to generate coupon offers or promotions to consumer based on NFT behavior, according to an embodiment.

FIG. 2 is a high-level block diagram illustrating an architecture of the NFT Engine and its components, according to an embodiment.

FIG. 3 is a block diagram illustrating an exemplary architectural view of a sports NFT marketplace and applications, according to an embodiment.

FIG. 4 is a block diagram illustrating the elements of the LogicWare with artificial intelligence, blockchain and Web3 interfaces, according to an embodiment.

FIG. 5 illustrates the use of verified credentials (VCs) for authentication into the ecosystem of applications for access control or user onboarding features, according to an embodiment.

FIG. 6 is a more detailed block diagram illustrating a location transaction module of the system of FIG. 1, according to an embodiment.

FIG. 7 is a high-level flow diagram illustrating a method for generating coupon offers to consumers based on NFT behavior, according to one embodiment.

FIG. 8 is a more detailed flow diagram illustrating an alternative method for generating coupon offers to consumers based on NFT behavior, according to one embodiment.

FIG. 9 is a block diagram illustrating an example computing device for the system of FIG. 1, according to one embodiment.

### DETAILED DESCRIPTION

Methods, computer program products, and systems are provided for recording user data for retailers that may be available at a particular location, online over a website or a mobile application, or in a virtual or metaverse environment and can further segregate based on a particular time at the location tailor offers to a user based on the characteristics, types or information, and behavior associated with a user's NFTs. One of ordinary skill in the art will recognize many alternative embodiments that are not explicitly listed based on the following disclosure.

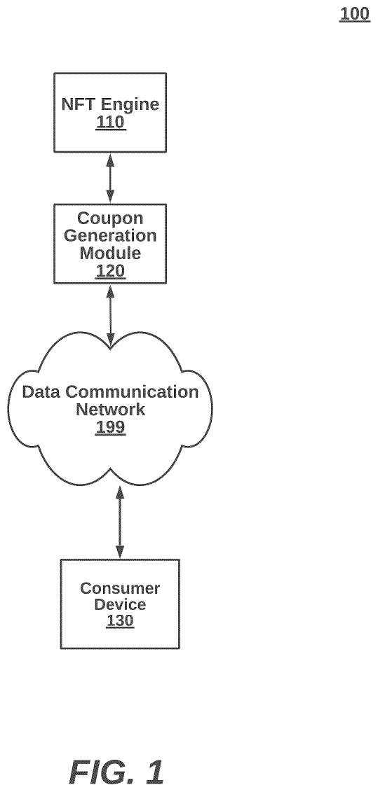

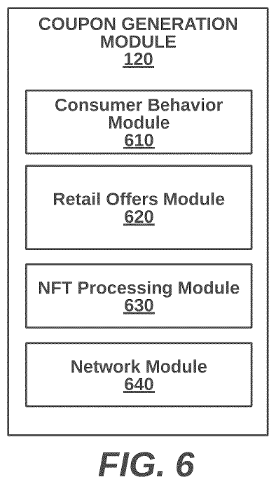

### I. Systems for NFT Behavior-Based Coupons (FIGS. 1-6)

FIG. 1 is a high-level block diagram illustrating a system 100 for generating coupon offers to consumers based on NFT behavior, according to one embodiment. The system 100 includes an NFT engine 110, a coupon generation module 120 interacting over a data communication network 199 with a consumer device 130, as users of the system 100. In one embodiment, the NFT engine 110 and the location transaction module 120 are integrated into a single physical device, and in another embodiment, communicate across the data communication network 199. Many other variations are possible.

In one embodiment, the NFT engine 110 mints and allocates tokens based on location-triggered events and provides access to token-gated content, in response to a user satisfying specified token criteria. The NFTs can also be minted in accordance with other operational or marketing objectives-for example as part of a fan voting experience, or as a membership in a DAO (decentralized autonomous organization). If fan voting is to be restricted to fans or loyal customers of the retailer, the location triggered module can be optionally integrated. Other ways of minting the tokens include but are not limited to
a. Promotional NFTs for driving sales for an event, prior to the event itself or for services
b. Live NFT drops during the duration of an event or a game that may optionally be tied to other activities in a stadium or an arena where such an event may be taking place
c. Rewarding a coupon to consumers who engage in a physical activity such as a meet and greet opportunity with a celebrity, or a treasure hunt at a venue or at any authorized promotional event
d. Retail brands can create NFTs from user generated content and provide as coupons to the creators themselves;
e. Auctions: The platform can put a specific item up for auction, with the highest bidder being awarded the NFT. This can be particularly effective for rare or one-of-a-kind collectible or promotional items.
f. Collaborations: A collaborative NFT may involve collaborating with other brands, artists, or creators to create unique NFTs that combine their styles or content. These can also be sponsored by some advertisers wishing to reach a particular demographic, based on their data and behavioral patterns. For example, a golf apparel company may provide a 20% discount coupon as a limited set of NFTs featuring an athlete.
g. Exclusive releases: This involves releasing a limited number of NFTs tied to coupons for experiences at a specific event or occasion, such as a music festival or movie premiere, that may be only accessible to certain consumers.

The NFT platform described herein takes the complexity of the blockchain environment and abstracts it into a set of APIs and SDKs that can manage the entire process easily. For example, crypto wallets are front end technologies that require user interaction and input to mint an NFT from a smart contract. The NFT platform here has turned it around and made it into a backend and middleware technology by managing the complexity away from the user and providing for interaction via APIs. As such any front end application can now interact with the blockchain without burdening the users with the intricacies of storing or managing their private keys and authorizing transactions to sign transactions to interact with the blockchains and mint, redeem, or create NFTs. A proxy process can be deployed in the backend that abstracts the user signatures as part of the transaction. At the backend, the transactions can also be handled by custodial wallets, or multi-signature wallets that can associate the transactions to the user accounts. The backend is capable of supporting multiple applications simultaneously and while each application may be deployed by a unique customer. The NFT engine 110 maps the backend databases, digital assets or coupons, and the blockchain layer interaction to provide a simple workflow for businesses and enterprises.

It may be noted that the LogicWare also provides for creating wallets with various ways of protecting the private keys. The private keys can be stored on a Hardware Security Module (HSM), or in Key Management Systems (KMS), whose keys may be further entrusted to an encrypted vault. The keys can also be managed using a multi party computation (MPC) process that enables multiple parties to jointly compute a function without revealing their private inputs to each other. As part of the key management contemplated by this invention, LogicWare can distribute the private key across multiple parties in a way that ensures that no single party has access to the full private key. Instead, each party holds a share of the private key, and only by combining all shares can the full private key be reconstructed. Finally, irrespective of the key security mechanism described above, if at any time, a holder of the private key so desires, they can take complete control of their private keys via LogicWare.

For users of such a system, it is important that the system should be easy to use and also provide for secure authentication. It is also important that the system not allow for deconstruction of personal identities based on the coupons or marketing data and analytics. As such, authentication plays an important role. An authentication module can optionally store login information and authenticate users against the blockchain information. As detailed below, the system can deploy decentralized IDs to enable selective disclosure of information or identity attributes. A user's public key may be stored on the blockchain which allows anyone to verify the authenticity of messages, transactions, or other data associated with that identity. A user in the ecosystem (customer, brand, entity, business, retailer) may store identity-related data on the blockchain, such as verifiable claims, which are claims that have been cryptographically signed by them and can be verified by others without revealing any additional information about the identity. Also, Zero knowledge proofs can be implemented to ensure that information about a user can be verified without sharing any personally identifiable information or protected information. Finally, verified credentials can also be deployed to ensure trustworthiness of the system.

A verified credential as part of this invention is a digital representation of a piece of identity-related data that has been cryptographically signed by a trusted authority. These credentials can include things like a person's name, date of birth, address, or loyalty reward number or any other information as defined above relevant to coupons and marketing data. In a DID system, verified credentials are used to help establish trust between different parties. For example, when a user wants to prove their identity to a service provider (brand, retailer, marketing agency, loyalty program provider.), they can present a verified credential that has been issued by a trusted authority such as a retailer, a government agency or any other trusted participant in the ecosystem. The service provider can then cryptographically verify the authenticity of the credential without having to rely on a centralized identity provider. These verified credentials can be stored on the blockchain, along with the decentralized identity and associated public keys. This allows them to be accessed and verified by anyone in the network without the need for a centralized intermediary. Additionally, because the credentials are cryptographically signed, they cannot be tampered with or altered without detection. Overall, verified credentials help to provide a more secure, private, and flexible approach to identity management, enabling individuals and organizations to assert and control their identities without relying on centralized intermediaries.

The NFT engine 110 offers a comprehensive suite of features designed to enhance user interaction and accessibility. Firstly, users have access to location information directly from their devices. They can log into any website, mobile application, chat or video application, or a 3D metaverse environment powered by gaming engines such as Unity or Unreal, ensuring seamless connectivity regardless of the platform.

Optionally, a geofence can be configured around various physical locations such as retail venues, conference halls, convention centers, airports, stadiums, or arenas, limiting interaction to participants within these specified areas. When location capability is enabled, users entering the geofenced area can seamlessly interact with the application.

LogicWare 600, along with APIs and SDKs, facilitates the development of personalized coupon applications in various forms, including single web apps, native mobile apps, or monolithic client applications. Features may be split between client and server ends, with separate roles designated for users and admins.

The application can be triggered in multiple ways, including scanning a QR code, accessing a specific URL displayed by the venue, or being automatically configured in the backend and presented to the user as part of another application. Additionally, it can be sent to users as an SMS or message, or integrated with single sign-on (SSO) or a SAML assertion within an application.

Users can log in using email, any social network, single sign-on, or a SAML assertion. They can associate their login details with a wallet address on a blockchain (a public key) while storing a corresponding private key. Optionally, the application can create a decentralized identity wallet for the user, with verified credentials mapped to the user's profile information, ensuring privacy and security.

Users can claim a digital asset or digital coupon by presenting the public key to the application configured with a smart contract. Payment can be made by fiat, crypto, or by redeeming a code. Whitelisted wallet addresses are allowed to mint an asset or coupon, while blacklisted wallet addresses are blocked by the application. The private key is optional to redeem the asset, and the system can create medical records or clinical trial records using the system private keys or multi-sig techniques.

The application is governed by smart contracts, which can be EVM compatible or custom developed for specific blockchains such as Near or Solana. These smart contracts allow for various types of digital assets or coupons, including unique digital assets or coupons (ERC 721), copies of unique digital assets or coupons (ERC 1155), mix and match of various other digital assets or coupons (ERC998), and semi-fungible tokens (ERC3525). They also allow for the rental of digital assets or coupons, with assets or coupons created via the smart contract being importable within a metaverse environment or a 3D environment powered by any gaming engine.

Optionally, the application may allow for smart contract deployment by creating a private key/wallet address pair for deployment of the smart contract, separate from any other wallet, known as a deployment wallet. This wallet does not hold any digital assets (NFTs) but may hold cryptocurrencies and can pay for transactions related to the digital assets created via the smart contract. Transactions may also be paid by an eventual buyer or redeemer of the digital assets or coupons. This solution could be linked or part of an enterprise-deployed solution, with smart contracts automatically configured and deployed via API calls, on demand in real-time, and on a choice of blockchains or test network environments.

Digital assets or coupons are created and stored, with creative elements such as pictures, audio, or video content, along with associated data related to the business, user, affiliates, or ecosystem partner for whose benefit the NFT may be created. All data and metadata may be stored centrally on any internet-connected server or in a decentralized manner using protocols such as IPFS or Arweave, ensuring security and accessibility. Digital assets or coupons may or may not be transferable to any other wallet address on the blockchain, with payments processed by storing the confirmation ID and token ID as proof of payment on the blockchain when the token is minted.

In one embodiment, the NFT can be issued within one geofenced location and redeemed for a transaction in another geofenced location, with additional rules or user requirements overlaid or in addition to geofencing rules, ensuring flexibility and adaptability to various user scenarios.

The NFT engine 110, in an embodiment, mints and allocates cryptographic experiential tokens or personalized coupons based on, for example, a location-based event and entitling the user to access an experience, product or service. In another aspect, token-gated access is granted to a resource at a location based on location triggered events and providing access to token-gated content in response to a user satisfying specified token criteria.

The system 100 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE, WiFi, NFC, etc. and other capabilities. Digital wallets may provide a store of value or a credit or access to credit and may be in the form of a digital currency or involve a conversion to digital currency, tradeable digital asset or coupon, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions. As such, it is advantageous to create a decentralized identity for the user, so that their personal identity is secure and protected and that their privacy is not subject to unnecessary public scrutiny.

The coupon generation module 120, of this embodiment, includes a consumer behavior module 310, a retail offers module 320, an NFT processing module 330 and a network module 340. The consumer behavior module 310 tracks interactions between a consumer or a group of consumers with an NFT or group of NFTs. The retail offers module 320 can provide an interface for retailers to upload offers and behavior parameters being targeted. The NFT processing module 330 interoperates with the NFT engine 110 as a back end using APIs and other communication techniques to record transactions. The network module 340 uses communication channels such as Ethernet or cellular to send and receive transaction data and other data.

The coupon generation module 120 generates individualized coupons based on behavior patterns. Individualized coupons based on behavior patterns may refer to the use of data analytics and other technologies to create personalized coupons or discounts that are tailored to the individual customer's behavior and preferences. This can be a highly analytical marketing practice with NFTs, especially considering that (as described above) NFTs are essentially data wrappers with a variety of highly customizable data fields such as their description, attributes, and any other piece of data that can be appended to the metadata format, including but not limited to location, sponsor, images, videos, data sets, etc. This approach allows businesses to offer highly targeted and relevant promotions that are more likely to be accepted and redeemed by the customer.

To create individualized coupons based on behavior patterns, businesses need to collect and analyze data on the customer's past behavior and preferences. This data can be obtained through various sources, such as the customer's NFT history and how they interacted with the NFT itself. Businesses may create NFT based coupons and attach any sort of data with the coupons. This data can be stored either privately or publicly visible to anyone over decentralized storage networks such as IPFS or Arweave etc. The invention contemplates using various permutations and combinations of this dataset to provide meaningful analytics and insights for the business. This data can also be available via their CRM and ERP systems or loyalty programs etc. and can be integrated with the LogicWare platform. Some representative information may include:
A. Creator information: NFT metadata can include information about the creator of the NFT, such as their name, website, or social media handles. This can help identify the creator of the NFT and provide additional context for artwork or other features.
B. Creation date: NFT metadata can include the date that the NFT was created. This can help determine the age of the NFT and provide information about its historical significance.
C. Ownership history: NFT metadata can track the ownership history of the NFT, including the addresses of the previous owners and the dates of ownership transfers. This can help determine the authenticity and provenance of the NFT.
D. Transaction history: NFT metadata can include information about the transactions that have occurred with the NFT, including the price and date of the transaction. This can help determine the market value of the NFT and provide insights into buying and selling trends.
E. Rights and permissions: NFT metadata can include information about the rights and permissions associated with the NFT, such as the ability to reproduce or distribute the artwork. This can help ensure that the creator's rights are protected and provide additional context for the artwork.
F. Technical specifications: NFT metadata can include technical specifications about the NFT, such as the file type, resolution, and size. This can help ensure that the NFT is compatible with different platforms and provide additional information about the artwork.

Overall, NFT metadata can provide valuable insights into the history and ownership of an NFT, as well as additional context for coupons or promotional offers. This information can be helpful and valuable to gain a deeper understanding of the NFT ecosystem and make more informed decisions. AI agents can also be used to surface actionable data from NFT metadata.

AI agents are software programs that employ artificial intelligence techniques to operate autonomously or semi-autonomously in a variety of environments, making decisions based on input data, predefined rules, machine learning models, or a combination of these methodologies. Typically, AI agents are capable of performing tasks independently without human intervention, adjusting their actions based on the analysis of incoming data. In this way they are an extension of an analytics engine and make it easy to take actions based on the underlying analysis for the data that they operate upon, such as performance or other informational data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks.

These AI agents can be implemented using a variety of technical frameworks and methodologies, including but not limited to:

Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

It should be noted that this history does not explicitly include or require personally identifiable information, but comprises data analytics gleaned from the NFT and its metadata information. By analyzing this data, businesses can identify patterns and trends in the customer's behavior and preferences, and use this information to create customized coupons and discounts.

For example, a customer who frequently purchases a certain type of product from a business may receive an NFT encouraging them to be a member of a digital community that may be formed amongst the fans of the product. As a member of the community, the user may further receive multiple NFTs to interact with any promotion of the product or product category, or any other community that the business may create. These NFTs may include but not be limited to a coupon offering a discount on that product or tied to other products or services of the brand or from third party brands or providers.

Individualized coupons based on behavior patterns can provide several benefits for businesses. By offering relevant and personalized promotions, businesses can increase customer loyalty, engagement, enhance user experience and potentially increase sales. Additionally, by targeting their users with promotions more effectively, businesses can reduce the cost and effort associated with offering coupons and discounts, and increase the likelihood of a successful promotion. With NFTs, the businesses can not exploit user's personally identifiable information. Additionally, businesses can coordinate promotions or collectively tailor or customize products and services to individual or group NFT holders. In this way, co-branding opportunities can be based on predetermined or dynamically generated or adjusted based on NFT-related behaviors of a group or individual.

It may be noted that the coupons are associated with a user's digital wallet. These wallets are designed to provide a high level of anonymity to users, as they do not require personal information to be linked to the wallet. Crypto wallets use pseudonymous addresses to receive and send transactions, which means that users do not need to provide their real name or other identifying information. Instead, they are assigned a unique address that is used to send and receive cryptocurrencies. This makes it difficult for anyone to link the wallet to a specific individual or organization. This also makes it easier to comply with regulations.

AI agents can be used to facilitate automated data reporting service processes that may interact with the retail offers module 320 automatically. Such automated data reporting service processes may include:

1. Database services designed to manage, query, and report data from relational, non-relational, or vectorized databases efficiently.

2. Business intelligence tools that collect and process large amounts of unstructured data from internal and external systems, prepare it for analysis, develop queries against that data, and create reports, dashboards, and data visualizations.

3. Data Warehousing Solutions that aggregate data from multiple sources, making it easier to provide comprehensive reporting and analysis. They often include tools for automated reporting and data analysis.

4. AI powered analytics platforms that use artificial intelligence to analyze data and generate reports. They can identify patterns, trends, and anomalies without human intervention.

5. AI agents that meet specific business needs, capable of extracting data from various sources, analyzing it using machine learning models, and generating tailored reports. These agents can be trained to provide insights specific to the business's operational, tactical, or strategic queries.

These automated data processing reporting services may also include spreadsheet tools with automation features, API based tools, cloud based reporting services, ETL (extract, transform, load) tools or any combination of the above.

Overall, individualized coupons based on behavior patterns can be an effective way for one or collective businesses to offer personalized promotions and increase customer engagement and loyalty. In either case, opportunities can be based on predetermined or dynamically generated or adjusted based on NFT-related behaviors of a group or individual.

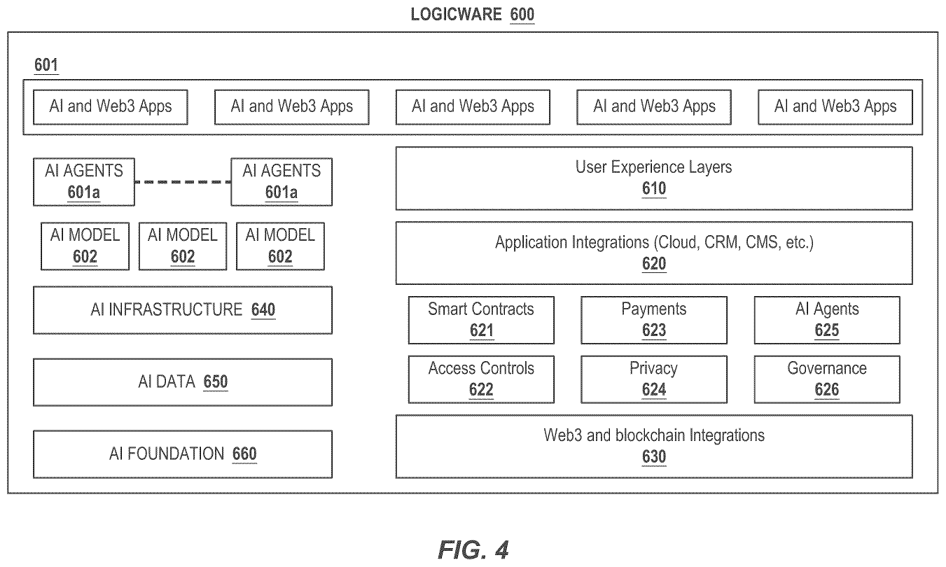

### III. Methods for NFT Behavior-Based Coupons (FIG. 4)

User data collection: In order to associate users with NFT coupons, businesses need to collect data on their behavior. This can include information such as the user's transaction history. Optionally, businesses may track a user's browsing behavior, and social media activity via methods that are well known in the art.

Tokenization: Once the user data has been collected, it can be tokenized and stored on a blockchain, or encoded into a set of attributes that the business can use for future purposes of interacting with the user's wallet. Tokens allow for secure and transparent tracking of user behavior.

NFT creation: Once the user data has been tokenized, NFT coupons can be created that are tailored to the user's behavior or characteristics. For example, a user who frequently purchases a particular product or services might receive an NFT coupon that offers a discount on that product or services (or related or complementary product or service), or they could receive additional NFT coupons from one or more businesses that may be affiliated to the attributes identified with their wallets.

Redemption: Users can redeem their NFT coupons at participating businesses, either by presenting the coupon on their mobile device or by using a QR code or other digital authentication methods. There are several benefits to using NFT coupons that are associated with user behavior. Some examples include:

Increased customer engagement: By tailoring coupons to individual users based on their behavior, businesses can increase customer engagement and loyalty. This can lead to higher sales and increased customer retention.

Improved tracking and analytics: By using blockchain technology to track user behavior, businesses can gain valuable insights into their customers' buying habits and preferences. This can help them to create more effective marketing campaigns and product offerings.

Enhanced security: NFT coupons are stored on a blockchain, which provides a high level of security and prevents fraud and counterfeiting. This means that businesses can be confident that their coupons are being redeemed by legitimate users.

Greater flexibility: NFT coupons can be easily customized and updated, which allows businesses to quickly respond to changes in customer behavior or market trends. This flexibility can help businesses to stay competitive and adapt to changing market conditions.

Multi-tier redemption: NFTs can also be redeemed in tiers. For example, a secondary or next level product or service can be offered only if a previous or related activity or behavior occurs from an NFT. In one embodiment, once a first NFT for a first product or service is used or activated, only then can a second or related NFT coupon or promotion be activated. Higher and higher level NFTs can be generated with greater levels of service or exclusivity.

Trading or Selling of NFT: optionally, a smart contract can allow for the trading of an NFT coupon or promotion by an NFT holder. In this way, businesses can incentivize certain behaviors by an individual or group and then allow that individual or group to sell, trade or redeem the NFT. If a business can determine how an NFT was acquired (e.g., over a branded marketplace), the businesses can appropriately target or tailor those markets or regions (for example, for which businesses were not aware or were undeserving).

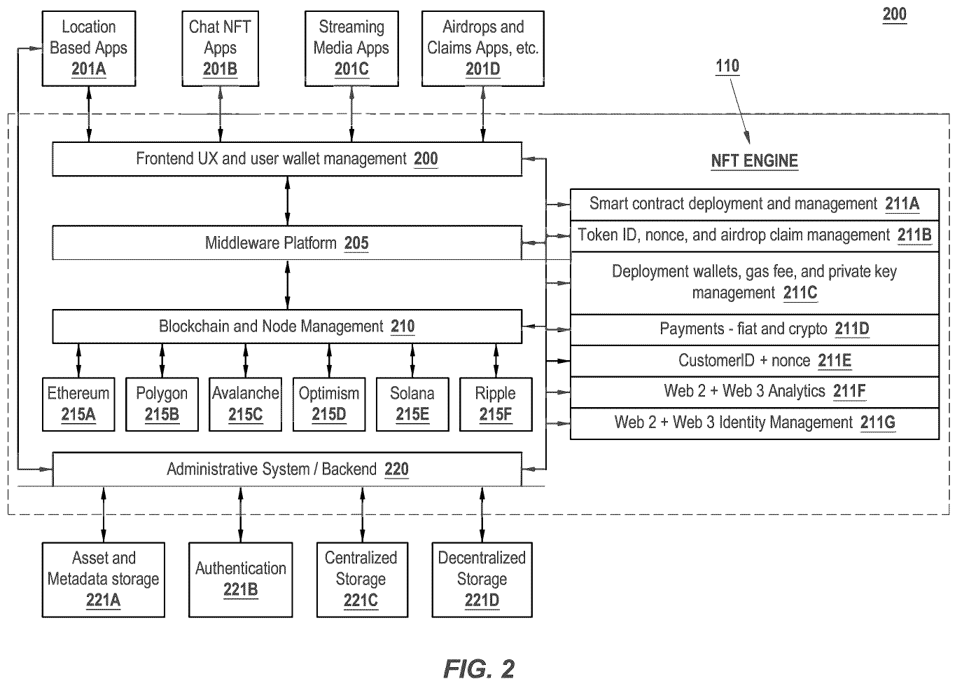

FIG. 2 illustrates one embodiment of a high-level architecture of the NFT Engine and its components. Various other components and modules can be added to the NFT Engine to accommodate customized NFT requirements.

The NFT Engine 110 interfaces with a variety of other software modules including the user experience modules and the core software infrastructure modules. In one embodiment, 201A is a location based application that is built using the NFT Engine 110. Location based apps 201A could also be a non location based application or any other generic application that provides blockchain and NFT functionality to the users. Coupon generation apps 201B is another application or module. Other applications from a user experience perspective may be streaming media or digital avatar apps such as 201C or AirDrop and claims applications such as 201D there may be many more applications that can be built on top of the NFT engine. These applications interface directly with the NFT engine via the front end UX and user wallet management modules 200. In addition these applications also interface with an administrative system or a backend, 220, which may be specific or customized for each application. The front end UX and user wallet management module 200 is connected to the NFT brewery middleware platform, 205, which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum 215A, Polygon 215B, Avalanche 215C, Optimism 215D, Solana 215E, Ripple 215F, or any other EVM or non-EVM blockchain via custom RPCs and APIs. In addition the back end 220 provides support for asset and metadata storage 221A, authentication 221B, centralized storage 221C, or decentralized storage 221D. Other modules and components of the NFTEngine include:

1. Smart contract deployment and management module (211A), that supports any underlying blockchain

2. TokenID, nonce, airdrop claim management modules (211B) to ensure individual transactions can be processed out of sequence as well in case certain transactions are held up in the execution queue.

3. Deployment wallets and scripts, wallet management including private key management and gas management (211C), with a variety of ways for managing private keys including encryption, utilizing key vaults, multi party computation techniques (MPC) or multi-signature wallet management.

4. Payments modules for both fiat as well as cryptocurrencies (211D) via payment gateways, integrating recording the transaction results and status directly into the blockchain.

5. CustomerID and Nonce management for individual customers (211E), similar to the user side described above, to ensure that transactions by different customers do not queue up and can be processed independently.

6. Integrated web2 and web3 analytics (211F) to map transactional information of users to their wallets. In addition, AI techniques and algorithms can be utilized to infer behavioral information about users independent of their demographic information.

7. Integrated web2 and web3 identity management (211G) that allows for access controls to be implemented based on the digital wallets, ownership of media or avatars, or any other digital goods or identity modules including SSO, SAML, etc.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology.

One of the key features of Web3 is the use of smart contracts, which are self-executing contracts with the terms of the agreement directly written into code. Smart contracts enable automated and tamper-proof agreements, facilitating various applications such as decentralized finance (DeFi), non-fungible tokens (NFTs), decentralized exchanges (DEXs), etc.

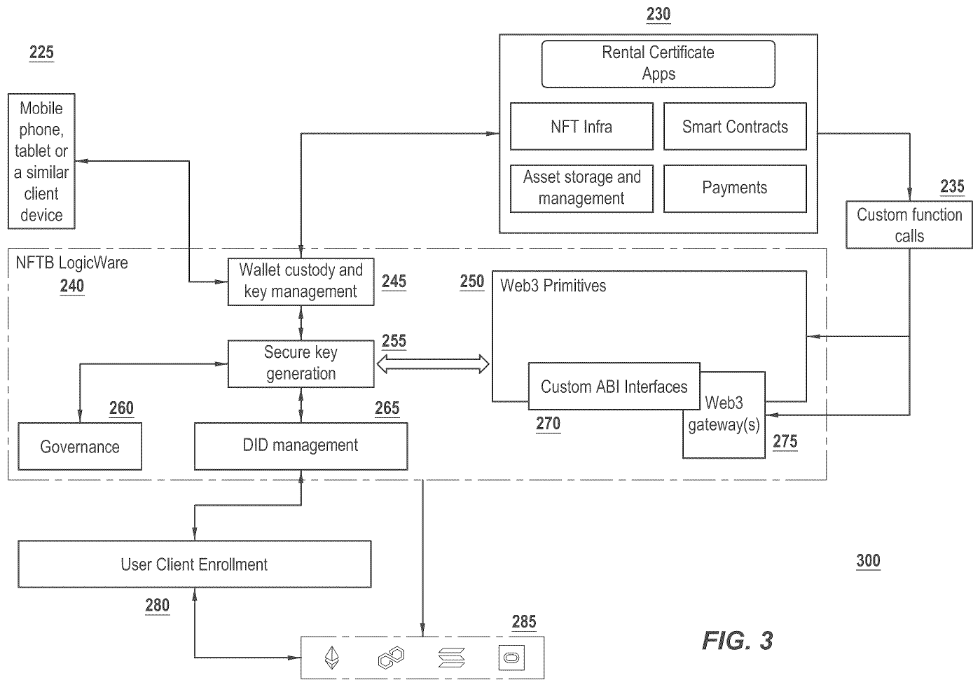

FIG. 3 illustrates an exemplary high level architectural view of an individualized coupon offering system based on NFT behavior embedded with customer support applications that can communicate with a mobile phone or other client device. Various other components and modules can be added to this architecture to accommodate customized NFT requirements.

The end user may log in into the platform using a mobile phone tablet or similar client device (225). The application running on the device interacts with the NFT middleware platform via the NFTB LogicWare (240). The LogicWare determines the wallet custody and key management protocol 245 that applies to the particular application (230) or the user and logs the user in into the application. If the user interacts with the application or dApp the first time, the custody and key management protocol 245 generates a new key pair using the secure key generation module 255 or the user and associates it with their identity. Optionally it may also associate the keys with a decentralized identity and issue verified credentials to the user. Additionally, LogicWare also creates or associates the governance policies that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, asset storage and management (221A, 221C, 221D), or payments 211D.

The application interfaces with the middleware and NFT engine 240 via custom function calls APIs and SDK's 235. The NFTB LogicWare includes various web3 primitives, 250, that are interoperable building blocks that are highly reliable in executing transactions over a blockchain, communicate with backend 220 and frontend 200 systems, work with storage components (221C, 221D), utilize analytics from modules such as web2 and web3 analytics 211F, identify users using the identity management module 211G, secure the applications using authentication, identity management, or implement access controls with 211G, 211B or provide for a governance layer in combination with the governance module 260. The web3 primitives 250 also communicate with custom ABI interfaces 270 and web3 gateways 275 for deploying smart contracts to their respective blockchains, interacting with smart contracts, and executing the functions and instructions in the smart contracts.

In addition, the LogicWare optionally comprises a governance (260) and a Decentralized Identity (DID) management module (265). DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The Governance module 260 within the NFTB LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module (265) is a part of the web2 and web3 identity management module (211G) described above. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module, 280, to create a system where the identities from one system may map directly to an identity on another system, without the need for any user intervention. For example, when making a private blockchain system to be compatible with a public blockchain such as Ethereum, Polygon or Solana, it may be essential to create a user (client) enrolment into the Hyperledger based system and map it to the private keys for the eventual user of the system.

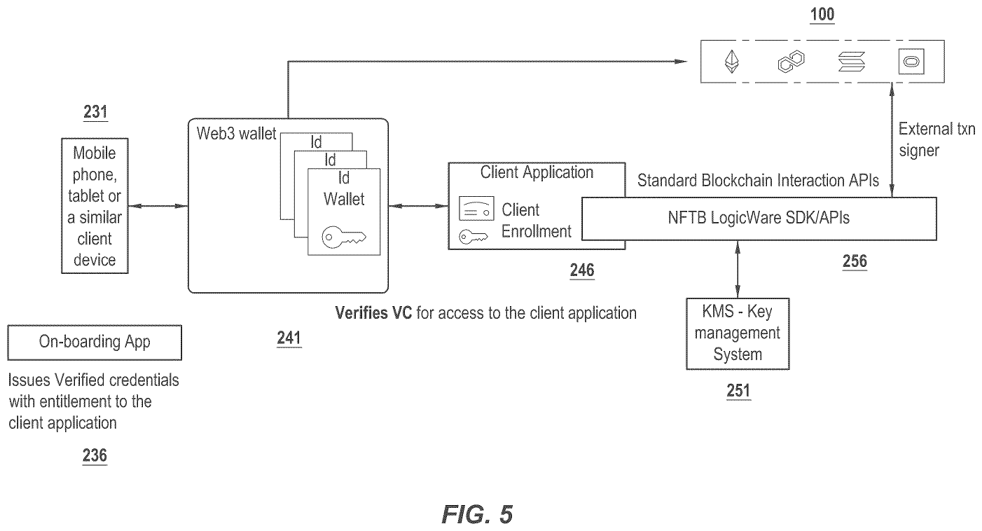

FIG. 5 illustrates the use of verified credentials (VCs) for authentication into the ecosystem of applications for access control or user onboarding features.

When a user logs in to the platform using a mobile phone, tablet, desktop, or a similar device 231 the onboarding application 236 or dApp issues a verified credential (VC), to the user. It may be noted that the VC may be issued by a third party application separately and imported into the client application. These VCs allow the user to access other connected applications or dApps that the user may wish to, such as loyalty programs, using their decentralized identity. As such, verified credentials (VCs) act as authenticating mechanisms for users to use the appropriate wallets as a proxy for their identity on the system. A user may have multiple wallets associated with their identity. When a user logs in to the application or dApp, the LogicWare 256 identifies the appropriate identity to use and retrieves the appropriate keys from the key management system, 251. This in turn allows the application or dApp 246 to transact with the blockchain using the appropriate identity and the private keys associated with them. A user's public key may be stored on the blockchain which allows anyone to verify the authenticity of messages, transactions, or other data associated with that identity.

Automated data reporting service processes such as artificial intelligence agents (or AI agents) are software programs or algorithms designed to perform specific tasks autonomously, making decisions and taking actions based on predefined rules, learning from data, or adapting through machine learning techniques. AI agents can leverage data, including data associated with NFTs, to perform various tasks and processes. AI agents are used in various applications across different domains, including:

Virtual Assistants: AI agents like Siri, Alexa, and Google Assistant interact with users, understand natural language, and perform tasks such as answering questions, setting reminders, and controlling smart home devices.

Chatbots: AI agents used in customer service and support systems to interact with users, answer questions, provide assistance, and handle simple tasks.

Recommendation Systems: AI agents analyze user behavior and preferences to provide personalized recommendations for products, movies, music, and content.

AI agents can be simple or complex, depending on the task they are designed to perform. They can also range from rule-based systems to advanced machine learning models capable of learning from data and improving their performance over time

AI agents can perform a wide range of tasks across various domains, including:
Natural Language Processing (NLP): AI agents can translate text or speech from one language to another (Language Translation), analyze text data to determine the sentiment expressed (Sentiment Analysis), and identify and classify entities mentioned in text data, such as names of people, organizations, or locations (Named Entity Recognition (NER));
Computer Vision and Object Detection: AI agents can identify and locate objects within images or videos;
Image Classification: AI agents can classify images into predefined categories;
Facial Recognition: AI agents can recognize and identify human faces in images or videos;
Data Analysis and Predictive Modeling: AI agents can analyze historical data to make predictions about future events or trends (Predictive Analytics), identify unusual patterns or outliers in data (Anomaly Detection) and forecast future values based on historical time series data (Time Series Forecasting);
Healthcare: AI agents can assist healthcare professionals in diagnosing diseases and medical conditions based on patient data. and can analyze patient data to recommend personalized treatment plans;
Finance: AI agents can analyze financial data and facilitate transactions, identify fraudulent activities by analyzing financial transactions and assess the creditworthiness of individuals or businesses based on their financial history;
Virtual Reality (VR) and Augmented Reality (AR): AI agents can enhance user experiences in VR and AR applications by providing intelligent interactions and personalized content.
Cybersecurity: Intrusion Detection: AI agents can detect and respond to security threats in computer networks/
Malware Detection: AI agents can identify and neutralize malicious software.
Content Creation: AI agents can generate text, images, music, and other forms of content automatically.
AI agents can be linked to NFTs in several ways:
Ownership and Authentication: NFTs can be used to prove ownership and authenticate AI agents. Each AI agent can be represented by a unique NFT, and ownership of the agent can be transferred via the NFT;
Training Data and Model: NFTs and their associated metadata can represent the training data used to train the AI agent or the model itself. This can ensure the transparency of the AI's capabilities and its training data;
Royalties and Intellectual Property Rights: NFTs can also be used to manage royalties and intellectual property rights associated with AI agents. Creators can receive royalties whenever their AI agents are used;
Marketplaces and Trading: NFT marketplaces can facilitate the trading of AI agents. Creators can sell, buy, or exchange AI agents using NFTs, with the ownership of the AI agent being transferred along with the NFT;
Customization and Upgrades: NFTs can represent unique features, attributes, or upgrades of AI agents. For example, owners can share or grant temporary access to NFTs to advertisers or approved third parties to represent these features and allow them to apply AI agents to customizing or personalizing communication according to preferences; and
Provenance and History: NFTs can store the provenance and history of an AI agent, including its previous owners, usage history, and any modifications made to it.

By linking AI agents to NFTs, creators can ensure ownership, authenticity, and traceability, while also providing a platform for trading, sharing, accessing, customizing, and monetizing data accessible by AI agents.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

A. Artificial intelligence for Gathering and Analyzing Data

FIG. 4 is a block diagram further illustrating the elements of the LogicWare with blockchain and Web3 interfaces. The system depicted in FIG. 4 abstracts away many of the complexities involved in building and operationalizing AI systems, enabling developers and applications to focus on leveraging AI capabilities rather than dealing with low-level infrastructure concerns. AI Foundation 660 refers to the underlying platform enabling the integration and deployment of AI capabilities with LogicWare. The AI Foundation serves as a common layer that provides essential services and components required for developing, deploying, and managing AI models and applications. AI Foundation may be part of the Logicware 110, deployed as SDKs or made available to Logicware via APIs. AI Foundation may include or support the following key elements:

Data ingestion and preprocessing: Components for collecting, cleaning, and preprocessing data from various sources to prepare it for use in AI models.

Model development and training: Tools and environments for building, training, and evaluating AI models 602, such as machine learning, deep learning, or natural language processing models.

Model management: Services for versioning, storing, and managing trained AI models 602, as well as monitoring their performance and updating them as needed.

Inference and deployment: Mechanisms for deploying trained AI models into production environments, allowing applications and systems to consume and leverage the AI capabilities.

Scalability and performance: Infrastructure 640 and services that enable the efficient scaling and high-performance execution of AI workloads, often involving specialized hardware like GPUs or TPUs and cloud-based services.

Security and governance: Mechanisms for ensuring the secure and compliant use of AI models, including access control, auditing, and adherence to regulatory requirements.

Integration and APIs: Interfaces with Application Integrations 630 and APIs that allow other applications and systems to seamlessly integrate and consume the AI capabilities provided by the foundation such as process systems 621-626.

AI Foundation 660 aims to provide a standardized and consistent platform for AI development and deployment with Logicware 110, across the organization, promoting reusability, scalability, and governance of AI solutions. Some of the features of the AI Foundation 660, may also integrate with cloud, CRM, CMS and other systems via Application Integrations 620.

AI Data 650 refers to the information used to train and develop artificial intelligence systems. This data can be in various forms, such as text, images, audio, or numerical data, depending on the application of the AI system. Ensuring the quality, relevance, and diversity of AI data is crucial for building accurate and unbiased AI models. AI data can be both structured and unstructured:

1) Structured data refers to information that is organized and formatted in a predefined way, such as databases, spreadsheets, or labeled datasets. This type of data is typically used for tasks like classification, regression, or structured prediction problems.

2) Unstructured data, on the other hand, refers to information that does not have a predefined format or structure, such as text documents, images, audio files, or social media posts. This type of data requires more preprocessing and feature extraction techniques before it can be used for training AI models.

3) Many AI applications, especially in areas like natural language processing (NLP) and computer vision, rely heavily on unstructured data, while structured data is more commonly used in fields like finance, healthcare, and manufacturing.

Logicware works with both structured and unstructured data which can also be integrated via application integrations 620.

AI infrastructure 640 refers to the combination of hardware and software resources required to develop, train, and deploy artificial intelligence systems effectively. It includes powerful computing resources, such as GPUS, TPUs, or specialized AI accelerators, to handle the computationally intensive tasks involved in training large AI models. AI infrastructure also encompasses the software platforms, frameworks, and tools used for data preprocessing, model building, training, and inferencing, which may also be a part of the AI Foundation. Additionally, AI Infrastructure 640 may involve storage and data management solutions to handle the vast amounts of data required for AI model training. The system in FIG. 4 enables robust AI infrastructure is crucial for organizations to scale their AI initiatives and achieve efficient model development and deployment cycles.

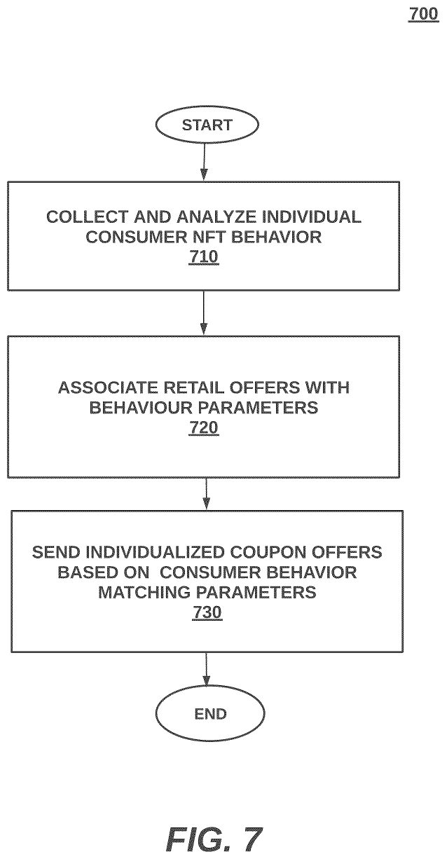

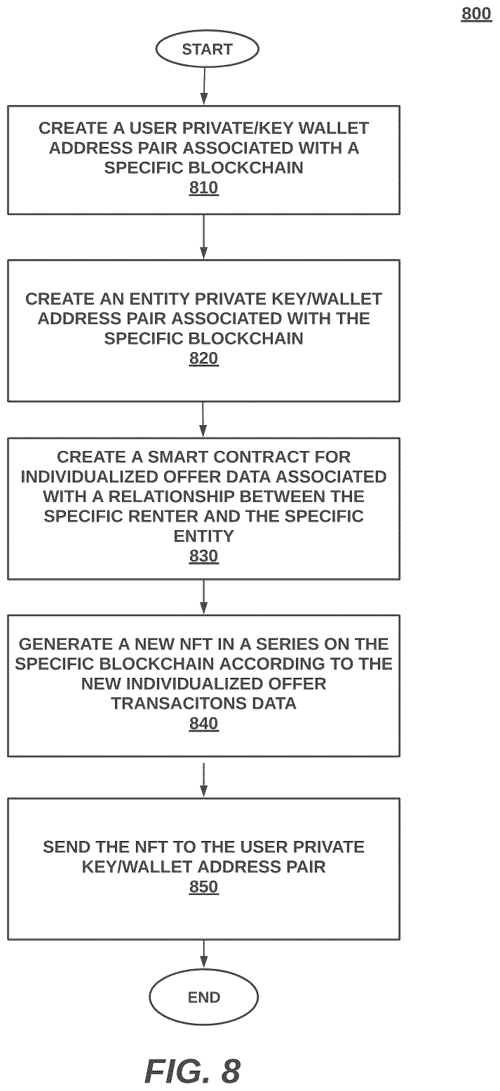

### II. Methods for NFT Behavior-Based Individualized Coupon Offering (FIGS. 7-8)

FIG. 7 is a high-level flow diagram illustrating a method 700 for sending individualized coupon offers based on consumer behavior, according to one embodiment. The method 700 can be implemented by, for example, system 100 of FIG. 1. At step 710, a consumer's NFT behavior is collected and analyzed. As described previously, this step collects and analyzes the metadata associated with NFTs, user behavior associated with NFTs and any information associated with other NFTs maintained or accessed in a user's wallet. At step 720, retail offers associated with behavior parameters and associated with the information processed at step 710. Certain offers can relate to a current time or current position. At step 730, users are sent individualized NFT-based coupon offers based on consumer behavior matching parameters. An NFT engine mints NFT tokens and processes and secures transactions.

FIG. 8 is a more detailed flow diagram illustrating an alternative method 800 for sending individualized coupon offers based on consumer behavior, according to an embodiment.

At step 810, a user private key/wallet address pair associated with a specific user is created to interact with the system, wherein the user private key/wallet address pair is associated with a specific blockchain.

At step 820, an entity private key/wallet address pair associated with a specific entity is created to interact with the smart contract and store at least a portion of the renter data associated with the specific user on the blockchain.

At step 830, a smart contract for user data associated with a relationship between a specific user and a specific entity is created in an individualized offer history database.

At step 840, a new NFT in a series on the specific blockchain is generated according to new offer data using the smart contract and authorized by the entity private key/wallet key pair of the specific chat session or the specific entity to activate the individualized offer history.

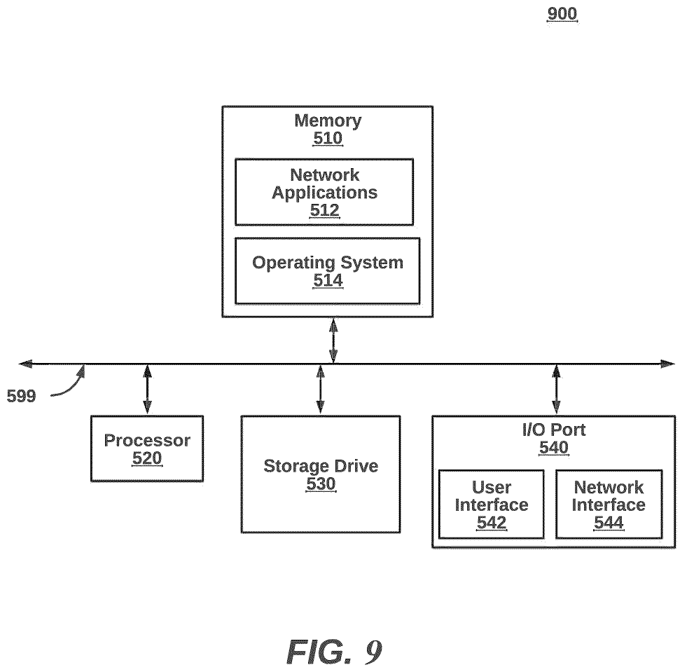

### III. Computing Device for NFT Behavior-Based Coupons (FIG. 9)

FIG. 9 is a block diagram illustrating a computing device 900 for use in the system 100 of FIG. 1, according to one embodiment. The computing device 900 is a non-limiting example device for implementing each of the components of the system 100, including NFT engine 110, location transaction module 120 and a consumer device 130. Additionally, the computing device 500 is merely an example implementation itself, since the system 100 can also be fully or partially implemented with laptop computers, tablet computers, smart cell phones, Internet access applications, and the like.

The computing device 900, of the present embodiment, includes a memory 510, a processor 520, a hard drive 530, and an I/O port 540. Each of the components is coupled for electronic communication via a bus 599. Communication can be digital and/or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access applications, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X etc, Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in the memory 510 or the hard drive 730.

The storage device 530 can be any non-volatile type of storage such as a magnetic disc, EPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a system, on a data communication network, for providing immutable individualized offer transactions within a non-fungible cryptographic token (NFT) based individualized offer certificate, the method comprising:
creating a user private key/wallet address pair associated with a specific user to interact with the system, wherein the user private key/wallet address pair is associated with a specific blockchain;
creating an entity private key/wallet address pair associated with a specific entity to interact with the smart contract and store at least a portion of the renter data associated with the specific user on the blockchain;
creating a smart contract for user data associated with a relationship between a specific user and a specific entity in an individualized offer history database;
generating a new NFT in a series on the specific blockchain according to new offer data using the smart contract and authorized by the entity private key/wallet key pair of the specific user session or the specific entity to activate the individualized offer history; and
sending the NFT to the user private key/wallet address pair.

2. A non-transitory computer-readable medium in a rental verification system, on a data communication network, storing code that when executed, performs a method for providing immutable individualized offer transactions within a non-fungible cryptographic token (NFT) based individualized offer certificate, the method comprising:
creating a user private key/wallet address pair associated with a specific user to interact with the system, wherein the user private key/wallet address pair is associated with a specific blockchain;
creating an entity private key/wallet address pair associated with a specific entity to interact with the smart contract and store at least a portion of the renter data associated with the specific user on the blockchain;
creating a smart contract for user data associated with a relationship between a specific user and a specific entity in an individualized offer history database; and
generating a new NFT in a series on the specific blockchain according to new offer data using the smart contract and authorized by the entity private key/wallet key pair of the specific chat session or the specific entity to activate the individualized offer history.

3. A customized offer system, on a data communication network, for providing immutable individualized offer transactions within a non-fungible cryptographic token (NFT) based individualized offer certificate, the rental verification system comprising:
a processor;
a network interface communicatively coupled to the processor and to a data communication network; and
a memory, communicatively coupled to the processor and storing:
a first module to create a user private key/wallet address pair associated with a specific user to interact with the system, wherein the user private key/wallet address pair is associated with a specific blockchain;
a second module to create an entity private key/wallet address pair associated with a specific entity to interact with the smart contract and store at least a portion of the renter data associated with the specific user on the blockchain;
a third module to create a smart contract for user data associated with a relationship between a specific user and a specific entity in an individualized offer history database; and
a fourth module to generate a new NFT in a series on the specific blockchain according to new offer data using the smart contract and authorized by the entity private key/wallet key pair of the specific user or the specific entity to activate the individualized offer history.
